(19) United States
(12) Patent Application Publication
(10) Pub. No.: US 2012/0146294 A1
(43) Pub. Date: Jun. 14, 2012

(54) BOOT SEAL FOR VARIABLE COMPRESSION-RATE ENGINE

(75) Inventors: Kenichi MITSUI, Kiyosu-shi (JP); Katsuhisa OTA, Kiyosu-shi (JP); Kaoru ITOU, Okazaki-shi (JP)

(73) Assignees: TOYOTA JIDOSHA KABUSHIKI KAISHA, Toyota-shi (JP); TOYODA GOSEI CO., LTD., Kiyosu-shi (JP)

(21) Appl. No.: 13/300,933

(22) Filed: Nov. 21, 2011

(30) Foreign Application Priority Data
Dec. 10, 2010 (JP) 2010-275722

(51) Int. Cl. F02F 11/00

(52) U.S. Cl. 277/596

(57) ABSTRACT

A boot seal for variable compression-rate engine includes a cylindrical boot-seal element, and a deformation inhibitor. The boot-seal element has an end being fixed to the cylinder block of the variable compression-rate engine, and another end being fixed to the crankcase. Moreover, the boot-seal element is provided with a bellows-shaped cylindrical deformer being made of an elastically deformable material. The deformation inhibitor is disposed outside or inside the boot-seal element in order to control the boot-seal element so as to deform outwardly or inwardly to a predetermined deformation magnitude.

### INCORPORATION BY REFERENCE

The present invention is based on Japanese Patent Application No. 2010-275,722, filed on Dec. 10, 2010, the entire contents of which are incorporated herein by reference.

### BACKGROUND OF THE INVENTION

1. Field of the Invention

The present invention relates to a boot seal to be mounted onto variable compression-rate engine.

2. Description of the Related Art

An engine has been known, engine into which the fuel-air mixture is supplied while changing the compression rate in compliance with the traveling conditions of vehicle (that is, a so-called variable compression-rate engine (being abbreviated to as “VCR” engine hereinafter)). The “VCR” engine makes it possible to retrieve higher torques by heightening the compression rate at the time of lower loads, and makes it possible to inhibit knocking from occurring by lowering the compression rate at the time of higher loads.

As one of the techniques for changing the compression rate of the fuel-air mixture to be supplied to engine, a technique for changing the volume of combustion chamber has been proposed. As the method of changing the volume of combustion chamber, the following technique is available: moving at least one of a cylinder block and a crankcase of an engine to change the relative positions of the two, thereby changing the volume of the combustion chamber of the engine. Hereinafter, an engine being made based on this technique will be referred to as a relative-displacement type “VCR” engine.

In a relative-displacement type “VCR” engine, the cylinder block and the crankcase change their relative positions. In general, the cylinder block moves in the up/down direction, thereby changing the relative positions between the cylinder block and the crankcase. Accordingly, in the relative-displacement type “VCR” engine, blow-by gases might possibly flow out from between the cylinder block and the crankcase. As a seal for inhibiting the blow-by gases, the present inventors proposed such a boot seal as proposed in Japanese Patent Application No. 2009-290,618.

As illustrated in FIG. 5, a boot-seal element 90 being set forth in Japanese Patent Application No. 2009-290,618 is a sealing element for covering between a cylinder block 81 and a crankcase 82. The boot-seal element 90 is formed as a cylindrical shape, and comprises a cylinder-block fitting 92, a crankcase fitting 93, and a deformer 91. The cylinder-block fitting 92 is mounted onto the cylinder block 81. The crankcase fitting 93 is mounted onto the crankcase 82. The deformer 91 is connected with the cylinder-block fitting 92 as well as the crankcase fitting 93. Moreover, the deformer 91 is formed of an elastically deformable material as a bellows-like cylindrical shape.

The cylinder-block fitting 92 includes a metallic cylinder head gasket 92a, and a central sheet 92b. The cylinder head gasket 92a is held between a cylinder head 83 and the cylinder block 81, thereby sealing between the cylinder head 83 and the cylinder block 81. Not only the central sheet 92b is formed around the circumferential rim of the cylinder head gasket 92a, but also it is embedded in the deformer 91 partially at least.

In the proposed boot-seal element 90, the bellows-like cylinder-shaped deformer 91 deforms (i.e., elongates or shrinks) to follow the relative movements between the cylinder block 81 and the crankcase 82. Moreover, the deformer 91 also deforms outwardly or inwardly (i.e., expands diametrically or contracts diametrically) because it is subjected to the pressures of the blow-by gases. Accordingly, the proposed boot-seal element 90 makes it possible to air-tightly seal between the cylinder block 81 and the crankcase 82. In addition, the proposed boot-seal element 90 includes the cylinder head gasket 92a that functions partly as the cylinder-block fitting 92. Consequently, it is possible for an assembly worker or robot to simultaneously carry out the following operations: mounting the cylinder head gasket 92a onto a relative-displacement type “VCR” engine; and mounting the proposed boot-seal element 90 onto the cylinder block 81. Therefore, the proposed boot-seal element 90 is good in terms of the overall workability in mounting.

In the proposed boot-seal element 90, the deformer 91 is always subjected to the pressures of the blow-by gases, ±5 kPa (the “+” sign represents the pressures in the direction of the flowing-out blow-by gases), for instance. In designing the proposed boot-seal element 90, the deformer 91 is set up to securely exhibit ±50 kPa pressure resistance, for instance, taking abnormal circumstances into consideration. For example, in the embodiments according to Japanese Patent Application No. 2009-290,618, an inexpensive thermoplastic elastomer polyester (i.e., TPEE) is used as a material for making the proposed boot-seal element 90. Moreover, the rigidity of the deformer 91 is enhanced by thickening the thickness of the deformer 91, thereby providing the deformer 91 with the pressure resistance securely.

When the deformer 91 deforms repetitively to follow the relative movements between the cylinder block 81 and the crankcase 82, cracks resulting from fatigues occur at parts in the deformer 91 where stresses are likely to concentrate. Thus, the proposed boot-seal element 90 reaches the time for replacement eventually.

Meanwhile, there also has been the need for reducing the number of times for replacing the proposed boot-seal element 90. In order to cope with such a need, it is possible to think of the method of making the deformer 91 of the resinous boot-seal element 90 thinner as far as the pressure resistance can be given to the deformer 91 so that it is unbreakable against the pressures of ±50 kPa. Making the thickness of the deformer 91 thinner leads to making the rigidity of the deformer 91 lower. As a result, it is possible to upgrade the durability of the proposed boot-seal element 90 against the repetitive deformations, because the stress concentrations can be relaxed at the thus thinned deformer 91.

Making the thickness of the deformer 91 thinner results in making the outward and inward deformation magnitudes of the deformer 91 greater against a given pressure. For example, the deformer 91 deforms outwardly and inwardly between the imaginary chain lines “Oₛ” and “Iₛ” against the ordinary pressures of ±5 kPa, as shown in FIG. 5. Moreover, the deformer 91 deforms outwardly and inwardly between the imaginary chain double-dashed lines “Oₘₐₓ” and “Iₘₐₓ” against the extraordinary pressures of ±50 kPa, as shown in FIG. 5.

If the deformer 91 should have deformed outwardly to more than the imaginary chain double-dashed line “Oₘₐₓ” to turn around, the deformer 91 should have deformed extraordinarily, or it should have interfered with the peripheral members. As a result, the deformer 91 might possibly rupture or break.

On the other hand, if the deformer 91 should have deformed inwardly to more than the imaginary chain double-dashed line “Iₘₐₓ” to be pulled in, the deformer 91 should have interfered with the cylinder block 81. As a result, the deformer 91 might possibly break. Moreover, under the condition that the deformer 91 should have been deformed inwardly to more than the imaginary chain double-dashed line “Iₘₐₓ” when the cylinder block 81 starts descending, the deformer 91 should have been bitten between the cylinder block 81 and the crankcase 82. As a result, the deformer 91 might possibly break likewise.

### SUMMARY OF THE INVENTION

The present invention has been developed in view of the aforementioned circumstances. It is therefore an object of the present invention to provide a boot seal that is disposed so as to cover between the cylinder block and crankcase of relative-displacement type “VCR” engine, boot seal which enables the boot-seal element to control its deformer's inward or outward deformation resulting from the pressures of blow-by gases within a predetermined deformation magnitude.

Hereinafter, descriptions will be made on subject matters according to the present invention that are suitable for solving the above-described problems that might take place, while mentioning the operations and advantages additionally, if needed.

A first subject matter according to the present invention is directed to a boot seal for variable compression-rate engine. The boot seal according to the first subject matter is mounted onto a variable compression-rate engine that changes a volume of a combustion chamber by changing relative positions between a cylinder block and a crankcase, and covers between the cylinder block and the crankcase. The boot seal according to the first subject matter comprises:

a cylindrical boot-seal element having an end being fixed to the cylinder block and another end being fixed to the crankcase, and including a bellows-shaped cylindrical deformer that is made of an elastically deformable material; and

a deformation inhibitor being disposed outside or inside the boot-seal element in order to control the deformer so as to deform outwardly or inwardly to a predetermined deformation magnitude.

The boot seal according to the first subject matter comprises the boot-seal element, and the deformation inhibitor that is disposed outside or inside the boot-seal element's deformer. The deformation inhibitor controls the boot-seal element so as to deform outwardly or inwardly to a predetermined deformation magnitude. Accordingly, the deformation inhibitor can prevent the boot-seal element's deformer from deforming extraordinarily. Moreover, the deformation inhibitor can prevent the deformer from interfering with the peripheral members. In addition, the deformation inhibitor can prevent the deformer from being bitten between the peripheral members, thereby inhibiting the deformer from rupturing or breaking. Note herein that the deformation inhibitor being disposed outside the boot-seal element can protect the boot-seal element from objects that try to collide with the boot-seal element from the outside.

Moreover, regardless of the rigidity of the boot-seal element's deformer, it is possible to inhibit the deformer from deforming more than a predetermined deformation magnitude against the pressure of ±50 kPa or more that the blow-by gases might exert under abnormal circumstances. Accordingly, it is possible to make the rigidity of the deformer. lower by making the thickness of the deformer thinner. Consequently, it is possible to upgrade the boot-seal element in the durability against the repetitive deformations, because the thus lowered rigidity leads to relaxing stress concentrations in the deformer. Note that the boot-seal element can preferably have a thickness at the deformer that falls in a range of from 1 to 4 mm, more preferably in a range of from 1.5 to 3 mm, for instance.

As described above, the first subject matter according to the present invention enables users to reduce troubles and costs for maintenance works, because the first subject manner diminishes the number of times for replacing the boot-seal element.

Moreover, making the thickness of the boot-seal element' s deformer thinner results in enabling manufacturers to reduce the material for making the boot-seal element. As a result, the first subject matter enables manufacturers to produce the boot seal according to the present invention more inexpensively.

Note that it is possible to dispose a cylindrical deformation inhibitor around the whole circumference of a cylindrical boot-seal element in order make the deformation inhibitor. Moreover, it is possible to dispose a plurality of deformation inhibitors around the whole circumference of a cylindrical boot-seal element at intervals of a predetermined separation distance between the deformation inhibitors.

A second subject matter is directed to the boot seal according to the first subject matter, wherein the deformation inhibitor can preferably includes:

a base end to be fixed to the cylinder block, or to a member that is fixed to the cylinder block; and

an elongation being extended from the base end in such a direction that the cylinder block and the crankcase move relatively to each other.

The boot seal according to the second subject matter comprises the deformation inhibitor whose base end is fixed to one of the constituents of the cylinder block, and whose elongation is extended in such a direction that the cylinder block and the crankcase move relatively to each other. Therefore, the deformation inhibitor makes a blind for the boot-seal element when it is disposed outside the boot-seal element. Thus, the deformation inhibitor can upgrade the appearance of the “VCR” engine in the decorativeness. Moreover, the deformation inhibitor can prevent moistures and/or oils from adhering onto the boot-seal element's outer face, because it makes an umbrella for the boot-seal element. In addition, the deformation inhibitor can protect the boot-seal element from heats that are evolved within the engine room of vehicle, especially, from heats that come from the “VCR” engine's exhaust manifold (or exhaust-piping assembly).

A third subject matter is directed to the boot seal according to the second subject matter, wherein the deformation inhibitor can preferably include the base end that is held between a cylinder head and the cylinder block, and which is provided integrally with an outer circumferential rim of a metallic cylinder head gasket for sealing between the cylinder head and the cylinder block.

The boot seal according to the third subject matter comprises the deformation inhibitor that is provided integrally with an outer circumferential rim of the metallic cylinder head gasket at the base end. Therefore, the deformation inhibitor enables an assembly worker or robot to simultaneously carry out the following two works: mounting the cylinder head gasket onto the “VCR” engine; and putting the deformation inhibitor in place on the “VCR” engine. That is, placing the deformation inhibitor thus in position leads to inhibiting the man-hour requirement for assembly from increasing.

Note that the term, “metallic, ” herein implies that a major material for making the cylinder head gasket is composed of a metal. For example, the term also indicates such a concept involving the metallic cylinder head gasket that is provided with a coated resinous film or membrane on the surface.

A fourth subject matter is directed to the boot seal according to the first subject matter, wherein the deformation inhibitor can preferably include:

a base end to be fixed to the crankcase, or to a member that is fixed to the crankcase; and

an elongation being extended from the base end in such a direction that the cylinder block and the crankcase move relatively to each other.

The boot seal according to the fourth subject matter comprises the deformation inhibitor whose base end is fixed to one of the constituents of the crankcase, and whose elongation is extended in such a direction that the cylinder block and the crankcase move relatively to each other. Therefore, the deformation inhibitor makes a blind for the boot-seal element when it is disposed outside the boot-seal element. Thus, the deformation inhibitor can upgrade the appearance of the “VCR” engine in the decorativeness. Moreover, the deformation inhibitor can protect the boot-seal element from heats that are evolved within the engine room of vehicle, especially, from heats that come from the “VCR” engine's exhaust manifold (or exhaust-piping assembly).

A fifth subject matter is directed to the boot seal according to the fourth subject matter that further comprises a retainer for fixing the boot-seal element to the crankcase at the other end, wherein:

the deformation inhibitor can preferably be disposed outside the boot-seal element; and

the deformation inhibitor can preferably include the base end that is provided integrally with the retainer.

The boot seal according to the fifth subject matter comprises the deformation inhibitor that is provided integrally with the retainer at the base end. Therefore, the deformation inhibitor enables an assembly worker or robot to simultaneously carry out the following two works: fixing the other end of the boot-seal element to the crankcase with the retainer; and putting the deformation inhibitor in place on the “VCR” engine. That is, placing the deformation inhibitor thus in position leads to inhibiting the man-hour requirement for assembly from increasing.

A sixth subject matter is directed to the boot seal according to the first subject matter, wherein:

the deformation inhibitor can preferably be disposed outside the boot-seal element; and

the deformation inhibitor can preferably be provided with a heat-resistant coating that is formed on an outer face thereof at least.

As described in the second and fourth subject matters according to the present invention, the deformation inhibitor can protect the boot-seal element from heats that are evolved within the engine room of vehicle, especially, heats that come from the exhaust manifold when the deformation inhibitor is disposed outside the boot-seal element. Note herein that the deformation inhibitor produces the advantage of protecting the boot-seal element from heats that are evolved within the engine room more effectively when it is provided with a heat-resistant coating on the outer face at least.

In particular, it is important to protect the boot-seal element from heats that are evolved within the engine room when a resin is used to make the boot-seal element, because resinous materials being capable of deforming elastically do not exhibit the heat resistance greatly so much.

A seventh subject matter is directed to the boot seal according to the first subject matter, wherein at least the deformer of the booth-seal element can preferably be made of a rubber that exhibits a safe heat-resistant temperature of 130° C. or more.

The boot seal according to the seventh subject matter comprises the boot-seal element at least whose deformer is made of a rubber that exhibits heat resistance to such temperatures as a safe heat-resistant temperature of 130° C. or more. The term, “safe heat-resistant temperature,” herein means a temperature to which the rubber is usable continuously without impairing the physical properties. Thus, the rubber makes the boot-seal element exhibit heat resistance sufficiently against heats that the boot-seal element receives from the exhaust manifold. Especially, the rubber can preferably exhibit a safe heat-resistant temperature that falls in a range of from 130° C. or more to 200° C. or less, more preferably in a range of from 130° C. or more to 160° C. or less.

Moreover, in addition to the higher heat resistance, the boot-seal element made of the rubber is superior to the boot-seal element made of resin in terms of the following: durability against repetitive deformations; oil resistance against oils held in the engine room; acid resistance and alkali resistance against acids and alkalis contained in the blow-by gases; and wear resistance against wears resulting from the interferences between the boot-seal element and peripheral members. Accordingly, using the boot-seal element made of the rubber leads to making the number of times for replacing the boot-seal element less. Consequently, the boot-seal element made of the rubber enables users to reduce troubles and costs for maintenance works furthermore.

An eighth subject matter is directed to the boot seal according to the seventh subject matter, wherein at least the deformer of the boot-seal element can preferably be made of a fluororubber.

The boot-seal element might be subjected to heats resulting from the exhaust manifold that reach 160° C. approximately. Hence, when at least the deformer of the boot-seal element is formed of a fluororubber (e.g., FKM) that exhibits a safe heat-resistance of 200° C., the fluororubber makes the boot-seal element that shows heat resistance reliably.

Moreover, even among various rubber materials, the fluororubber is one of the best materials that are good in terms of the heat resistance, durability, oil resistance and acid resistance as well as alkali resistance. Therefore, making the boot-seal element of the fluororubber results in intending to greatly extend the boot-seal element's longevity.

A ninth subject matter is directed to the boot seal according to the seventh subject matter, wherein the boot-seal element can preferably include a double-layered construction whose inner face is made of a fluororubber, and whose outer face is made of an ethylene acrylic rubber.

Although the fluororubber described in the eighth subject matter is one of the best materials that are good in terms of the heat resistance, durability, oil resistance and acid resistance as well as alkali resistance even in various rubber materials, it is a material that is much more expensive than are the other rubber materials. As a result, it might be necessary to keep down the material cost of the boot-seal element by making the thickness of the deformer thinner so as to manufacture the boot-seal element made of the fluororubber inexpensively.

On the contrary, an ethylene acrylic rubber (e.g., AEM) is a material that is less expensive than is the fluororubber, though it is inferior to the fluororubber in terms of the heat resistance, durability, oil resistance and acid resistance as well as alkali resistance. Note that, from the standpoint of using it as material to make the boot-seal element, an ethylene acrylic rubber effects heat resistance fully because it exhibits a safe heat-resistant temperature of 175° C.

The inner face of the boot-seal element is required to show higher heat resistance, durability, oil resistance and acid resistance as well as alkali resistance than does the outer face. Accordingly, in addition to giving the resultant boot seal rigidity securely, it is possible to keep the resulting fluororubber's thickness minimum by providing the boot-seal element with a double-layered construction whose inner face is made of a fluororubber and whose outer face is made of an ethylene-acrylic rubber. Consequently, the ninth subject matter according to the present invention enables manufacturers to produce the boot-seal element having the dual-layered construction more inexpensively than they produce the boot-seal element being all made of the fluororubber completely.

As described above, the subject matters according to the present invention make it possible to provide boot seals that can inhibit a bellows-shaped cylindrical deformer, namely, one of the constituent elements of a boot seal that is disposed so as to cover between the cylinder block and crankcase of relative-displacement type “VCR” engine, from deforming outwardly or inwardly mo re than a given deformation magnitude, regardless of the pressures of blow-by gases.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective diagram for illustrating a boot seal according to Embodiment No. 1 of the present invention.

FIG. 2 is a cross-sectional diagram for illustrating the boot seal according to Embodiment No. 1 that is cut imaginarily along the arrow-headed line “2”-“2” in FIG. 1.

FIG. 3 is a perspective diagram for illustrating a boot seal according to Embodiment No. 2 of the present invention.

FIG. 4 is a cross-sectional diagram for illustrating the boot seal according to Embodiment No. 2 that is cut imaginarily along the arrow-headed line “4”-“4” in FIG. 3.

FIG. 5 is a cross-sectional diagram for illustrating one of boot seals that the inventors of the present invention proposed in Japanese Patent Application No. 2009-290,618.

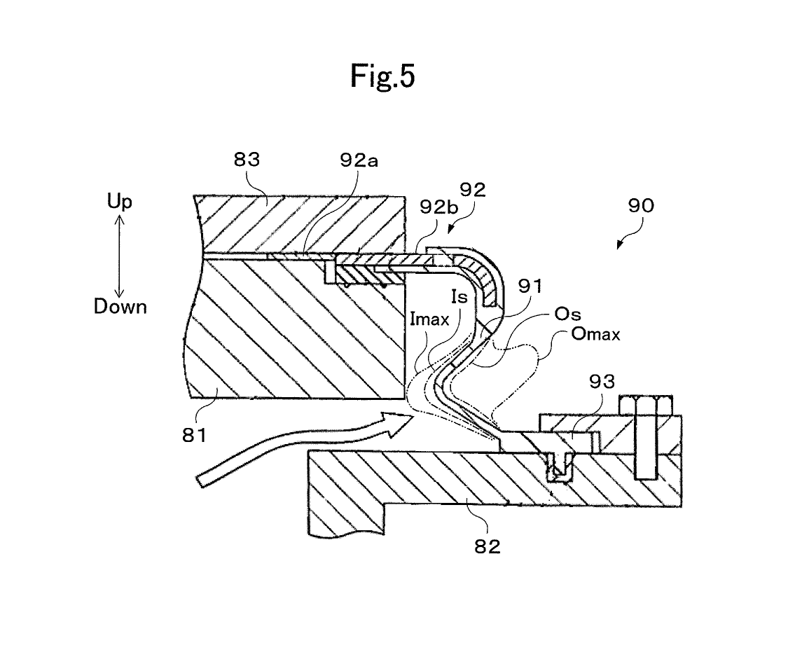

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Hereinafter, descriptions will be made in detail on embodiment modes that are directed to a boot seal for “VCR” engine according to present invention with reference to the accompanying drawings.

### Embodiment No. 1

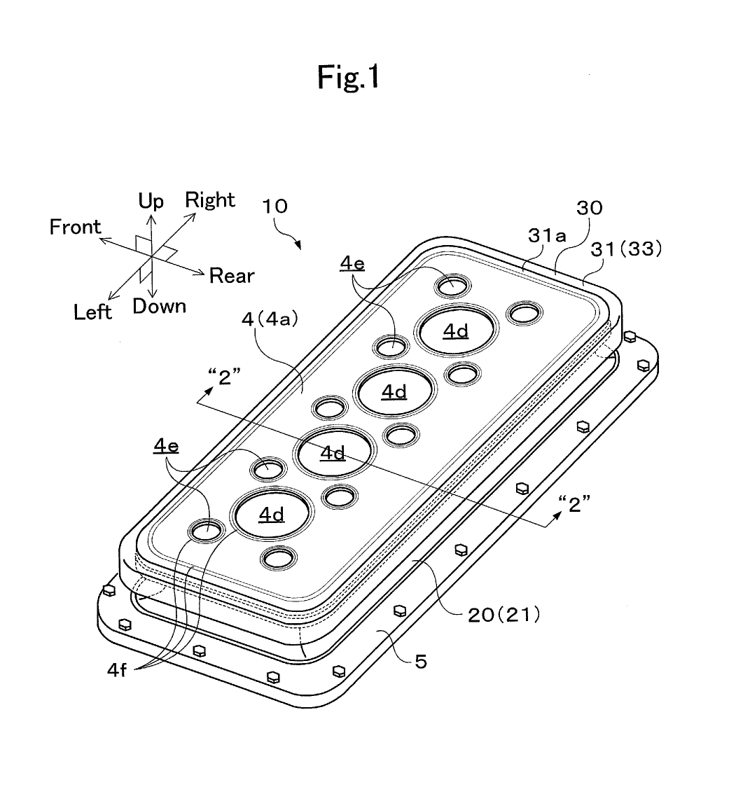

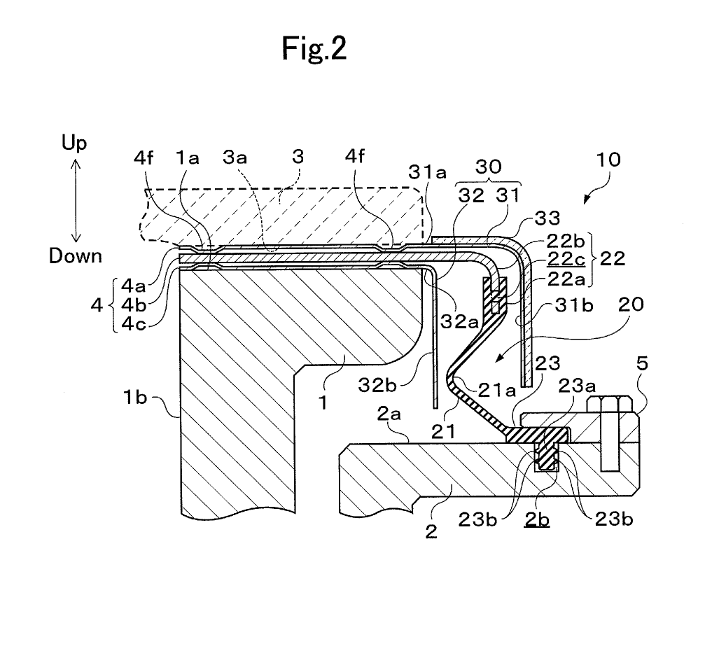

FIG. 1 illustrates a boot seal according to Embodiment No. 1 in a perspective view. FIG. 2 illustrates the present boot seal in a cross-sectional view in which it is cut imaginarily along the arrow-headed line “2”-“2” in FIG. 1. In the following descriptions, the terms, up, down, right, left, front and rear, refer to the “up,” “down,” “right,” “left,” “front” and “rear” that are specified in FIG. 1.

As illustrated in FIGS. 1 and 2, a boot seal 10 according to Embodiment No. 1 is disposed so as to cover between a cylinder block 1 and crankcase 2 of a relative-displacement type “VCR” engine. Note that FIG. 1 illustrates the relative-displacement type “VCR” engine with its cylinder head 3 being removed.

For reference, in the relative-displacement type “VCR” engine that relates to Embodiment No. 1, the lower end of the cylinder block 1 is inserted into the box-shaped crankcase 2 from above. Accordingly, the outer peripheral face of the cylinder block 1 and the inner peripheral face of the crankcase 2 face to each other. A not-shown moving mechanism moves the cylinder block 1 in the up/down direction. The cylinder head 3, which is installed to the cylinder block 1, also moves together with the cylinder block 1 integrally. Consequently, the relative positions between the cylinder block 1 and the crankcase 2 change to vary the volume of combustion chambers. For example, the cylinder block 1 is made movable by 4.5 mm upward, and by 4 mm downward, from the neutral position shown in FIG. 2.

The cylinder block 1 has a top face 1a. The top face 1a is flat, and is formed as a rectangular flat-face configuration that is long in the right/left direction. The cylinder block 1 is provided with four cylindrical inner faces 1b in the interior. The inner faces 1b pierce the cylinder block 1 in the up/down direction, and line up in the right/left direction. Not-shown pistons slide upward/downward against the inner faces 1b while coming in contact with them slidingly.

The crankcase 2 has a top face 2a. The top face 2a is flat, and is formed as a rectangular flat-face configuration that is long in the right/left direction. Moreover, as illustrated in FIG. 2, the outer circumferential rim of the top face 2a in the crankcase 2 projects outward beyond the outer circumferential rim of the top face 1a in the cylinder block 1. The outwardly-projecting outer rim of the top face 2a is provided with a lock groove 2b that opens upward. The lock groove 2b is formed as a rectangular oval- or arena-like shape so as to surround the cylinder block 1. A crankcase fitting 23 of a later-described boot-seal element 20 is locked into the lock groove 2b, and is then held between the crankcase 2 and a retainer 5, thereby being fixed to the lock groove 2b.

The cylinder head 3 has a bottom face 3a. The bottom face 3a is flat, and is formed as a rectangular flat-face configuration with the same dimensions as those of the top face 1a in the cylinder block 1. Moreover, the bottom surface 3a is provided with a cylinder head gasket 4 that is held between the top surface 1a in the cylinder block 1 and the bottom face 3a in the cylinder head 3, as shown in FIG. 2. In addition, the cylinder head 3 and the cylinder block 1 are fastened together by not-shown bolts.

The cylinder head gasket 4 is made of a metal, and is formed as a rectangular sheet-like shape having dimensions that are virtually equal to those of the top face 1a in the cylinder block 1. Specifically, the cylinder head gasket 4 comprises a laminate, which includes an outer metallic sheet 4a, an intermediate metallic sheet 4b and an inner metallic sheet 4c. The outer metallic sheet 4a, the intermediate metallic sheet 4b, and inner metallic sheet 4c are stacked in this order, and are then integrated by crimping. For example, the outer metallic sheet 4a is made of a stainless steel (e.g., SUS as per JIS (i.e., Japanese Industrial Standard)), and has a thickness of from 0.2 to 0.3 mm. The intermediate metallic sheet 4b is made of SUS, and has a thickness of from 0.6 to 0.8 mm. The inner metallic sheet 4c is made of SUS, and has a thickness of from 0.2 to 0.3 mm.

Moreover, the cylinder head gasket 4 is provided with a plurality of openings 4d for piston, and a plurality of other openings 4e for peripheral member. The openings 4d are formed in a quantity that conforms to the number of the relative-displacement type “VCR” engine's pistons (not shown), and are formed herein at four locations. Likewise, the other openings 4e are formed in a quantity that conforms to the number of peripheral members around the pistons, that is, the number of constituent members for the relative-displacement type “VCR” engine's cooling system and lubricating system, and are formed herein at ten locations.

The outer metallic sheet 4a, and the inner metallic sheet 4c are provided with a sealing protuberance 4f at the outer peripheral rim, respectively, as shown in FIG. 1. Moreover, the openings 4d for piston, and the openings 4e for peripheral member are also provided with a sealing protuberance 4f at the peripheral rim, respectively. The sealing protuberances 4f are processed circularly by press forming. The sealing protuberances 4f of the outer metallic sheet 4a project downward, whereas the sealing protuberances 4f of the inner metallic sheet 4c project upward, as shown in FIG. 2. When the cylinder head gasket 4 is held between the cylinder block 1 and the cylinder head 3, the protuberances 4f undergo elastic deformation to enhance the contact pressure between the outer metallic sheet 4a, intermediate metallic sheet 4b and inner metallic sheet 4c. Thus, the cylinder head gasket 4 seals between the cylinder block 1 and the cylinder head 3 reliably.

Moreover, as illustrated in FIG. 2, the outer metallic sheet 4a is provided with a base end 31a of a later-described plate- or sheet-shaped outer deformation inhibitor 31 integrally at the outer circumferential rim. In addition, the intermediate metallic sheet 4b is provided with a central-sheet end 22b of a later-described boot-seal element 20 integrally at the outer circumferential rim. Moreover, the inner metallic sheet 4c is provided with a base end 32a of a later-described plate- or sheet-shaped inner deformation inhibitor 32 integrally at the outer circumferential rim. To put it differently, the cylinder head gasket 4 is provided with the outer circumferential rims that are made continuously or uninterruptedly to or from a boot seal 10 according to Embodiment No. 1 without any definite boundary.

The boot seal 10 according to Embodiment No. 1 comprises a boot-seal element 20, and a plate- or sheet-shaped deformation inhibitor 30. The boot-seal element 20 is formed as a rectangular cylindrical shape, and is disposed so as to cover between the cylinder block 1 and the crankcase 2. The deformation inhibitor 30 controls the boot-seal element 20 so as to deform inwardly and outwardly to a predetermined deformation magnitude.

The boot-seal element 20 is provided with a deformer 21, a cylinder-block fitting 22, and a crankcase fitting 23. The deformer 21 is formed as bellows-like cylindrical shape, and is made of an elastically deformable material. The cylinder-block fitting 22 is apart for fixing the boot-seal element 20 to the cylinder block 1. The crankcase fitting 23 is a part for fixing the boot-seal element 20 to the crankcase 2.

For example, a fluororubber (e.g., FKM) exhibiting a safe heat-resistant temperature of 200° C. is used as a material for making the deformer 21. The deformer 21 is formed as a bellows-like cylindrical shape having at least a root 21a that dents inward diametrically. The deformer 21 has a thickness of 2 mm, for instance. The deformer 21 is integrated with the cylinder-block fitting 22 at one of the axial opposite ends (i.e., at the upper end in FIG. 2). Moreover, the deformer 21 is integrated with the crankcase fitting 23 at another one of the axial opposite ends (i.e., at the lower end in FIG. 2). Note that the deformer 21, a later-described embedding end 22a of the cylinder-block fitting 22, and the crankcase fitting 23 are molded by integral molding (or insert molding) with use of the same material.

The cylinder-block fitting 22 is made up of an embedding end 22a, and a central-sheet end 22b. The embedding end 22a is made of the fluororubber. The central-sheet end 22b is embedded in the embedding end 22a partially. Note that a part of the intermediate metallic sheet 4b with a thickness of from 0.6 to 0.8 mm, which is made with use of SUS as a material, makes the central-sheet end 22b. That is, the intermediate metallic sheet 4b makes at the outer circumferential rim the central-sheet end 22b that takes on a halved rectangular cylindrical shape. Specifically, the intermediate metallic sheet 4b is disposed so as to protrude beyond and then hang over the outer circumferential rim of the cylinder block 1 at its outer circumferential rim, and is then bent at the outer circumferential rim by 90 degrees, thereby giving the central-sheet end 22b a halved rectangular cylindrical shape, or an inverted rectangular vat- or pan-like shape. Moreover, the central-sheet end 22b is provided with a plurality of anchor holes 22c, which pierce the central-sheet end 22b horizontally, at the lower section over the entire periphery. The embedding end 22a, and the central-sheet end 22b are integrated firmly, because the embedding end 22a is molded by integral molding (or insert molding) so as to make it go into the anchor holes 22c fully.

Thus, the cylinder-block fitting 22 is assembled with the intermediate metallic sheet 4b of the cylinder head gasket 4 integrally at the embedding end 22a. As a result, the cylinder-block fitting 22 is fixed to the cylinder block 1 by mounting the cylinder head gasket 4 onto the cylinder block 1.

The crankcase fitting 23 is made with use of the fluororubber as a material, and is formed as rectangular oval- or arena-like shape. The crankcase fitting 23 is provided with a downwardly-projecting rectangular disk-shaped lock 23a on the lower face over the entire periphery. Moreover, the lock 23a is provided with a plurality of prong-shaped sealing ribs 23b that project diametrically outward and inward in FIG. 2.

When the crankcase fitting 23 is fixed onto the crankcase 2, the lock 23a of the crankcase fitting 23 is inserted from above into the lock groove 2b that is impressed into the top face 2a of the crankcase 2. Thus, the respective sealing ribs 23b come in press contact with the groove walls of the lock groove 2b. Moreover, a rectangular oval- or arena-like sheet-shaped retainer 5 is fastened by bolts onto the top face 2a of the crankcase 2. As a result, the crankcase fitting 23 is mounted on the crankcase 2 while producing high sealing capability, because it is held between the crankcase 2 and the retainer 5.

The deformation inhibitor 30 is provided with a plate- or sheet-shaped outer deformation inhibitor 31, and an inner deformation inhibitor plate 32. The outer deformation inhibitor 31 is disposed outside the boot-seal element 20, whereas the inner deformation inhibitor 32 is disposed inside the boot-seal element 20.

The outer deformation inhibitor 31 is made up of a base end 31a, and an elongation 31b. The base end 31a is to be fixed onto one of the parts in the cylinder block 1. The elongation 31b is extended from the base end 31a in such a direction that the cylinder block 1 and the crankcase 2 move relatively to each other (i.e., downward in FIG. 2). Specifically, the base end 31a is a part of the outer metallic sheet 4a with a thickness of from 0.2 to 0.3 mm that is made with use of SUS as a material so as to protrude beyond and then hang over the outer circumferential rim of the cylinder block 1 at its outer circumferential rim, whereas the elongation 31b is another part of the outer metallic sheet 4a that is made into a halved rectangular cylindrical shape, or an inverted rectangular vat- or pan-like shape, by bending the base end 31a downward at the outer circumferential rim by 90 degrees. Moreover, the outer deformation inhibitor 31 is provided with a heat-resistant coating 33 on the outer peripheral surface. The heat-resistant coating 33 contains hollow silica, and is formed by painting.

The elongation 31b is elongated down below slightly downward more than is the root 21a of the deformer 21 in the boot-seal element 20. Note that it is possible to elongate the elongation 31b to such positions that the leading end of the elongation 31b do not interfere with the peripheral members, such as the retainer 5, when the cylinder block 1 has moved downward to the lowest extent.

Moreover, the interval or spacing between the elongation 31b and the boot-seal element 20 is set up reliably in the following manner. When an ordinary pressure of +5 kPa acts on the deformer 21 of the boot-seal element 20 (note that the sign, “+,” represents the direction of pressures that the blowing-out blow-by gases exert), the elongation 31b is kept from coming in contact with the deformer 21. On the contrary, when an abnormal pressure (e.g., more than +50 kPa) acts on the deformer 21 so that the deformer 21 deforms outward greatly, the elongation 31b comes in contact with the deformer 21. Accordingly, it is possible to prevent the deformer 21 from inverting outwardly in response to abnormal pressures that might possibly act on the deformer 21. Consequently, it is possible to control the deformer 21 so as to deform outwardly to a predetermined deformation magnitude against the abnormal pressures.

The inner deformation inhibitor 32 is made up of a base end 32a, and an elongation 32b. The base end 32a is to be fixed onto one of the parts in the cylinder block 1. The elongation 32b is extended from the base end 32a in such a direction that the cylinder block 1 and the crankcase 2 move relatively to each other (i.e., downward in FIG. 2). Specifically, the base end 32a is a part of the inner metallic sheet 4c with a thickness of from 0.2 to 0.3 mm that is made with use of SUS as a material so as to protrude beyond and then hang over the outer circumferential rim of the cylinder block 1 at its outer circumferential rim, whereas the elongation 32b is another part of the inner metallic sheet 4c that is made into a halved rectangular cylindrical shape, or an inverted rectangular vat- or pan-like shape, by bending the base end 32a downward at the outer circumferential rim by 90 degrees.

The elongation 32b is elongated down below slightly lower than is the root 21a of the deformer 21 in the boot-seal element 20. Note that it is possible to elongate the elongation 32b to such positions that the leading end of the elongation 32b do not interfere with the peripheral members, such as the top face 2a of the crankcase 2, when the cylinder block 1 has moved downward to the lowest extent.

Moreover, the interval or spacing between the elongation 32b and the boot-seal element 20 is set up reliably in the following manner. When an ordinary pressure (e.g., more than −5 kPa) acts on the deformer 21 of the boot-seal element 20 (namely, under the condition that the pressures turn into being represented by the “−” sign (or negative pressures) within the crankcase 2), the elongation 32b is kept from coming in contact with the deformer 21. On the contrary, when an abnormal pressure of −50 kPa acts on the deformer 21 so that the deformer 21 deforms inward greatly, the elongation 32b comes in contact with the deformer 21. Thus, it is possible to control the deformer 21 so as to deform inwardly to a predetermined deformation magnitude against abnormal pressures that might possibly act on the deformer 21.

The thus constructed boot seal 10 according to Embodiment No. 1 comprises the outer deformation inhibitor 31, and the inner deformation inhibitor 32. The outer deformation inhibitor 31 is disposed outside the boot-seal element 20, whereas the inner deformation inhibitor 32 is disposed inside the boot-seal element 20. The outer deformation inhibitor 31 and inner deformation inhibitor 32 control the deformer 21 of the boot-seal element 20 so as to deform outwardly and inwardly to a predetermined deformation magnitude, respectively. As a result, the outer deformation inhibitor 31 and inner deformation inhibitor 32 can prevent the deformer 21 of the boot-seal element 20 from deforming abnormally. Moreover, they can prevent the deformer 21 from interfering with the peripheral members. In addition, they can prevent the ruptures or breakages in the deformer 21 that result from the deformer 20 that has been bitten between the peripheral members.

Moreover, regardless of the rigidity of the deformer 21 in the boot-seal element 20, the outer deformation inhibitor 31 and inner deformation inhibitor 32 inhibit the deformer 21 from deforming more than a predetermined deformation magnitude, respectively, in proportion to the blow-by gases' abnormal pressures of more than ±50 kPa. Accordingly, the outer deformation inhibitor 31 and inner deformation inhibitor 32 make it possible to lower the rigidity of the deformer 21 by making the boot-seal element 20 thinner at the deformer 21. Consequently, they make it possible to relax stress concentrations at the deformer 21 and then upgrade the boot-seal element 20 in the durability against repetitive deformations.

In addition, independent of the rigidity of the deformer 21 in the boot-seal element 20, the outer deformation inhibitor 31 and inner deformation inhibitor 32 control the deformer 21 so as to deform outwardly and inwardly to a predetermined deformation magnitude, respectively. As a result, the outer deformation inhibitor 31 and inner deformation inhibitor 32 enable manufactures to substitute a fluororubber (e.g., FKM) for one of polyester-system thermoplastic elastomers (e.g., TPEE), which have been heretofore used conventionally as materials for making the boot-seal element 20. Note that FKM exhibits a Young's modulus that is lower than that of TPEE by a factor of 1/10.

Moreover, instead of the conventional resins, using the fluororubber as a material for making the boot-seal element 20 results in upgrading the boot-seal element 20 not only in the heat resistance but also in the durability against repetitive deformations, the oil resistance against oils within engine rooms, the acid resistance and alkali resistance against acid and alkalis that the blow-by gases contain, and the wear resistance against the interferences, slides or wears between the boot-seal element 20 and the peripheral members.

In addition, the boot seal 10 according to Embodiment No. 1 comprises the boot-seal element 20 which is made using the fluororubber (e.g., FKM) as a material. Since the fluororubber is superior to the other various rubber materials in terms of the heat resistance, durability, oil resistance and acid resistance as well as alkali resistance, the boot-seal element 20, one of the constituents of the boot seal 10 according to Embodiment No. 1, has a longer life. Moreover, since the fluororubber exhibits a safe heat-resistant temperature of 200° C., the boot-seal element 20 shows heat resistance reliably against heats of 160° C. approximately that it receives from the relative-displacement type “VCR” engine's exhaust manifold (or exhaust-piping assembly).

As described above, since the number of times for replacing the boot-seal element 20 is reduced in the boot seal 10 according to Embodiment No. 1, it is possible for users to intend to reduce troubles and costs for maintenance works.

Moreover, making the thickness of the deformer 21 in the boot-seal element 20 thinner results in reducing the material for making the boot-seal element 20. Accordingly, manufacturers can produce the boot-seal element 20 inexpensively by thinning the boot-seal element 20. In particular, since the boot seal 10 according to Embodiment No. 1 comprises the boot-seal element 20 that is made of the FKM, an expensive material, it might be important for manufacturers to make the thickness of the deformer 21 thinner in order to keep down the manufacturing costs of the boot-seal element 20.

The boot seal 10 according to Embodiment No. 1 comprises the outer deformation inhibitor plate 31 and inner deformation inhibitor plate 32 with which the cylinder head gasket 4 is provided integrally around the outer circumferential rim. Accordingly, it is possible for an assembly worker or robot to simultaneously carry out the operation for mounting the cylinder head gasket 4 onto the relative-displacement type “VCR” engine, and the operation for putting the outer deformation inhibitor 31 and inner deformation inhibitor 32 in place. That is, an assembly worker or robot does not have to carry out the putting work at all when carrying out the mounting work. Consequently, it is possible for manufactures to inhibit the assembly man-hour requirements from increasing.

Moreover, the boot seal 10 according to Embodiment No. 1 comprises the outer deformation inhibitor 31 which is provided with the base end 31a and the elongation 31b. Not only the base end 31a is fixed to one of the parts in the cylinder block 1, but also the elongation 31b is elongated in such a direction that the cylinder block 1 and the crankcase 2 move relatively to each other. As a result, the outer deformation inhibitor 31 can upgrade the relative-displacement type “VCR” engine's appearance in the decorativeness, because it serves as a blind for the boot-seal element 20. Moreover, the outer deformation inhibitor 31 can prevent water and oils from adhering onto the outer face of the boot-seal element 20, because it serves as an umbrella for the boot-seal element 20. In addition, the outer deformation inhibitor 31 can protect the boot-seal element 20 from colliding objects, as well as from the heats inside an engine room, especially, from the heats that the exhaust manifold evolves.

In addition, the boot seal 10 according to Embodiment No. 1 produces the advantageous effect of protecting the boot-seal element 20 from the heats inside an engine room in a more enhanced manner, because the outer deformation inhibitor 31 is provided with the heat-resistant coating 33 on the outer peripheral face.

### Embodiment No. 2

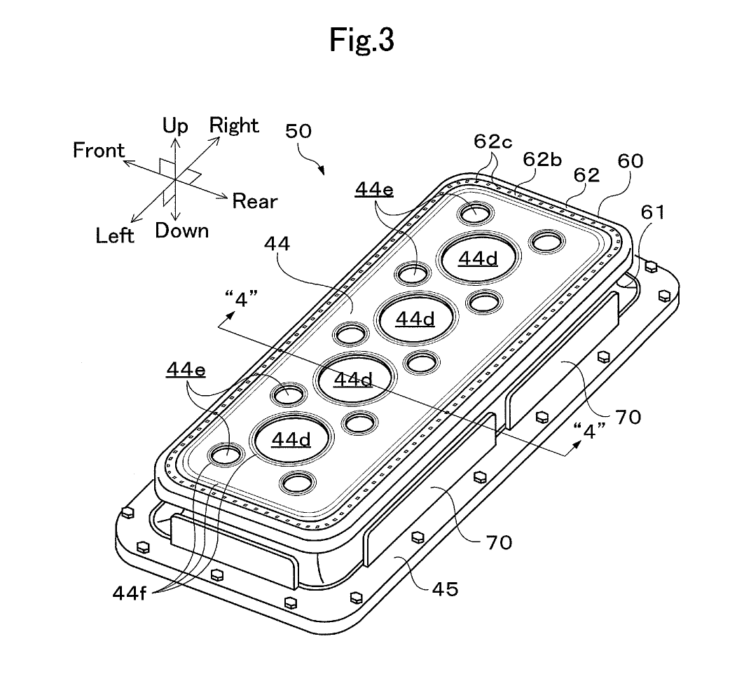

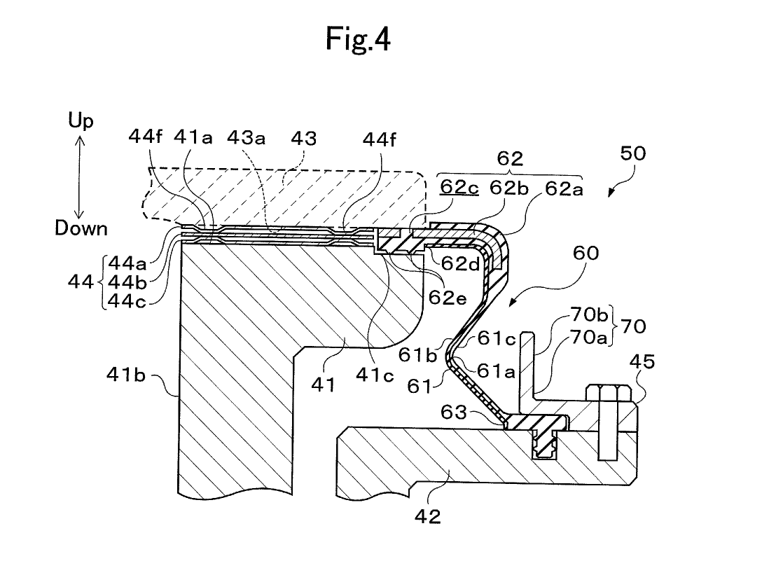

FIG. 3 illustrates a boot seal 50 according to Embodiment No. 2 in a perspective view. FIG. 4 illustrates the present boot seal 50 in a cross-sectional view in which it is cut imaginarily along the arrow-headed line “4”-“4” in FIG. 3. In the following descriptions, the terms, up, down, right, left, front and rear, refer to the “up,” “down,” “right,” “left,” “front” and “rear” that are specified in FIG. 3.

As illustrated in FIGS. 3 and 4, the boot seal 50 according to Embodiment No. 2 is disposed so as to cover between a cylinder block 41 and crankcase 42 of a relative-displacement type “VCR” engine in the same manner as the boot seal 10 according to Embodiment No. 1. FIG. 3 illustrates how the top of the relative-displacement type “VCR” engine appears when the cylinder head 43 is removed. Note that the relative-displacement type “VCR” engine, which is directed to the boot seal 50 according to Embodiment No. 2, has the same fundamental construction as that of the relative-displacement type “VCR” engine, which is directed to the boot seal 10 according to Embodiment No. 1. Hence, descriptions will be omitted herein on the relative-displacement type “VCR” engine's fundamental constitution.

One of major distinctions between Embodiment No. 2 and Embodiment No. 1 is that the boot seal 50 according to Embodiment No. 2 comprises a plate- or sheet-shaped deformation inhibitor 70 being fixed to one of the parts in the crankcase 42, whereas the boot seal 10 according to Embodiment No. 1 comprises the deformation inhibitor 30 whose outer deformation inhibitor 31 is fixed to one of the parts in the cylinder block 1. Moreover, Embodiment No. 2 is distinct from Embodiment No. 1 in that it comprises the cylinder block 41, a cylinder head gasket 44, a retainer 45 and the boot seal 50 that are constructed differently from those of the boot seal 10 according to Embodiment No. 1. No descriptions will be made herein on the constructions of the crankcase 42 and cylinder head 43, because the crankcase 42 and cylinder head 43 have the same constructions as those described in Embodiment No. 1.

As illustrated in FIG. 4, the cylinder block 41 has a top face 41a. The top surface 41a is formed as a flat rectangular shape that is longer in the right/left direction in the drawing than in the front/rear direction. Moreover, the top face 41a is provided with a shoulder 41c at the circumferential rim. That is, the top face 41a is depressed like a step lower at the shoulder 41c than at the other central part. As a result, the separation or interval between the cylinder head 43 and the cylinder block 41 is narrower at the central part in the cylinder block 41, and is wider at the circumferential rim. In addition, a cylindrical inner face 41b is formed at four locations inside the cylinder block 41. The cylindrical inner faces 41b pierce the cylinder block 41 in the up/down direction in the drawing, and align one after another in a raw in the right/left direction.

The cylinder head gasket 44 is made of a metal, and is formed as a rectangular sheet-like shape. Contrary to the cylinder head gasket 4 in Embodiment No. 1, the cylinder head gasket 44 is neither protruded toward nor beyond the shoulder 41c of the cylinder block 41 at the outer circumferential rim. Specifically, the cylinder head gasket 44 is made up of an outer metallic sheet 44a, an intermediate metallic sheet 44b and an inner metallic sheet 44c that make a stack in this order from the top to the bottom. The thus stacked outer metallic sheet 44a, the intermediate metallic sheet 44b, and inner metallic sheet 44c are integrated by crimping. Similarly to the cylinder head gasket 4 in Embodiment No. 1, the outer metallic sheet 44a, the intermediate metallic sheet 44b, and the inner metallic sheet 44c are made of a material being composed of SUS, respectively. However, each of the outer metallic sheet 44a, the intermediate metallic sheet 44b and the inner metallic sheet 44c has an equal thickness of from 0.2 to 0.3 mm.

In the same manner as the cylinder head gasket 4 in Embodiment No. 1, the cylinder head gasket 44 is provided with a plurality of openings 44d for piston, and a plurality of other openings 44e for peripheral member. In the same fashion as the cylinder head gasket 4 in Embodiment No. 1, the outer metallic sheet 44a, and the inner metallic sheet 44c have undergone press forming so that they are provided with a rectangular oval- or arena-shaped boss 44f (that is for sealing) at the outer circumferential rim, respectively. Likewise, the openings 44d for piston, and the openings 44e for peripheral member have undergone press forming so that they are provided with a ring-shaped boss 44f (that is for sealing) around the circumferential rim, respectively.

The boot seal 50 according to Embodiment No. 2 comprises a boot-seal element 60, and a plate- or sheet-shaped deformation inhibitor 70. The boot-seal element 60 has such a rectangular cylindrical shape that covers between the cylinder block 41 and the crankcase 42. The deformation inhibitor 70 is disposed outside the boot-seal element 60, thereby inhibiting the boot-seal element 60 from deforming outwardly more than a predetermined deformation magnitude.

The boot-seal element 60 is made of a material being composed of an elastically deformable material, and is provided with a deformer 61, a cylinder-block fitting 62, and a crankcase fitting 63. The deformer 61 is formed as bellows-like cylindrical shape. The cylinder-block fitting 62 makes a part of the boot-seal element 60 for fixing it to the cylinder block 41. The crankcase fitting 63 makes another part of the boot-seal element 60 for fixing it to the crankcase 42.

The deformer 61 comprises a double-layered construction that is made up of an inner face 61b and an outer face 61c. A thin layer being composed of a fluororubber (e.g., FKM) makes the inner face 61b, and another thin layer being composed of ethylene acrylic rubber (e.g., AEM) makes the outer face 61c. The deformer 61 has a thickness of 2 mm in total, because the fluororubber thin layer has a thickness of 1 mm and the ethylene-acrylic-rubber thin layer has a thickness of 1 mm, for instance. The fluororubber exhibits a safe heat-resistant temperature of 200° C., whereas the ethylene acrylic rubber exhibits a safe heat-resistant temperature of 175° C. Note that the fluororubber thin layer is provided on the entire inner face of the boot-seal element 60 that involves the inner face 61b of the deformer 61. Moreover, the deformer 61 has a bellows-like cylindrical shape being provided with at least a root 61a that dents inward diametrically. In addition, the boot-seal element 60 is further provided with the cylinder-block fitting 62, and the crankcase fitting 63. The cylinder-block fitting 62 unites with one of the axial opposite ends of the deformer 61 (i.e., with the upper end in FIG. 4), whereas the crankcase fitting 63 unites with another one of the axial opposite ends of the deformer 61 (i.e., with the lower end in FIG. 4). Note that the outer face 61c of the deformer 61, a later-described embedding end 62a of the cylinder-block fitting 62, and the crankcase fitting 63 have undergone integral molding (or insert molding) using the same material, namely, the above-described ethylene acrylic rubber.

The cylinder-block fitting 62 is provided with an embedding end 62a, and a central-sheet end 62b. The embedding end 62a is made of ethylene acrylic rubber as a material. The embedding end 62a buries or holds a part of the central-sheet end 62b in itself. The central-sheet end 62b is made of SUS with a thickness of from 0.6 to 0.8 mm as a metallic material, and is formed as a halved rectangular cylindrical shape, or an inverted rectangular vat- or pan-like shape. Moreover, the central-sheet end 62b is provided with a top face that is flush with the top face of the cylinder head gasket 44 virtually, and is bent by 90 degrees at around the outer circumferential rim so as to take on a halved rectangular cylindrical shape, or an inverted rectangular vat- or pan-like shape. In addition, the central-sheet end 62b is provided with a plurality of anchor holes 62c on the inner circumferential side over the entire periphery. The anchor holes 62c pierce the central-sheet end 62b vertically or in the up/down direction in FIG. 4.

As illustrated in FIG. 4, the deformer 61 has undergone integral molding (or insert molding) so that a part of the embedding end 62a goes into the anchor holes 62c fully. As a result, the embedding end 62a unites with the central-sheet end 62b firmly. Moreover, the embedding end 62a covers the bottom face of the central-sheet end 62b entirely. In addition, the embedding end 62a is provided with a sealing section 62d integrally at the leading end. The sealing section 62d has a strip shape that is formed as a hollowed rectangular oval or arena when being viewed from above. Moreover, the sealing section 62d is provided with a pair of pointed sealing ribs (62e, 62e) on the bottom face. The paired sealing ribs (62e, 62e) not only take on a shape of oval- or area-like running tracks but also project from the bottom face of the sealing section 62d downward in the drawing.

After placing the sealing section 62d of the cylinder-block fitting 62 on the shoulder 41c of the cylinder block 41, the central-sheet end 62b and sealing section 62d of the cylinder-block fitting 62 are held between the shoulder 41c of the cylinder block 41 and the bottom face 43a of the cylinder head 43. Accordingly, the cylinder-block fitting 62 is fixed onto the cylinder block 41. Note that the paired sealing ribs (62e, 62e) come in press contact with the shoulder 41c. Consequently, the cylinder-block fitting 62 is mounted on the cylinder block 41 while sealing between the cylinder block 41 and the cylinder head 43 highly tightly.

The crankcase fitting 63 is made of a material being composed of the ethylene acrylic rubber. Since crankcase fitting 63 is constructed and is then fixed onto the crankcase 42 in the same manner as described in Embodiment No. 1, descriptions are omitted herein on the construction and fixing method.

The plate- or sheet-shaped deformation inhibitor 70 is made up of a base end 70a, and an elongation 70b. The base end 70a is formed integrally with the inner circumferential rim of the retainer 45. Alternatively, the base end 70a can be fixed integrally to the inner circumferential rim of the retainer 45. The elongation 70b is extended from the base end 70a upward in FIG. 4, namely, in a direction of the relative movements between the cylinder block 41 and the crankcase 42. For example, the deformation inhibitor 70 is made of a plate- or sheet-shaped material with a thickness of from 1 to 3 mm that is composed of SGCC (as per JIS), one of galvanized steel plates or sheets. Moreover, the deformation inhibitor 70 is formed integrally from out of the retainer 45. Note that the boot-seal element 60 is less likely to deform at the corners than at the linear sections in FIG. 3 because it exhibits higher rigidity at the corners than at the linear sections in the drawing. Therefore, the deformation inhibitor 70 is disposed only at the linear sections of the retainer 45, not all around or over the entire circumference including the linear sections as well as the corners in the drawing. In addition, the thus disposing the deformation inhibitor 70 in a quantity of plural pieces, that is, separating the deformation inhibitors 70 from each other at predetermined intervals, results in making it possible to prevent oils from residing or turning into reservoirs between the boot-seal element 60 and an integral deformation inhibitor 70.

The elongation 70b is elongated upward slightly up above more than is the root 61a of the deformer 61 in the boot-seal element 60. Since the interval or spacing between the elongation 70b and the boot-seal element 60 is set up in the same manner as that in Embodiment No. 1, and since the elongation 70b operates to inhibit the deformer 61 of the boot-seal element 60 from deforming outward more than a predetermined deformation magnitude in the same manner as does the elongation 31b in Embodiment No. 1, descriptions are left out herein on the setup and operations.

Moreover, since the deformation inhibitor 70 in Embodiment No. 2 constructed as above produces advantages that are virtually equal to those produced by the outer deformation inhibitor 31 in Embodiment No. 1, no descriptions are made herein on the advantages. Hereinafter, descriptions will be made on advantages produced by Embodiment No. 2 alone that are distinct from those produced by Embodiment No. 1.

In the boot seal 50 according to Embodiment No. 2, FKM, one of flurororubbers, and AEM, one of ethylene acrylic rubbers, are used as materials for making the boot-seal element 60. The AEM is inferior to the FKM, which is also employed for making the boot-seal element 20 in Example No. 1, in terms of the heat resistance, durability, oil resistance, and acid resistance as well as alkali resistance. However, the AEM is more inexpensive than is the FKM. Moreover, the AEM exhibits a safe heat-resistance temperature of 175° C. As a result, the boot-seal element 60, which makes the boot seal 50 according to Embodiment No. 2, shows heat resistance reliably against heats of 160° C. approximately that it receives from the relative-displacement type “VCR” engine's exhaust manifold (or exhaust-piping assembly), even when it is made of the AEM partially.

Moreover, the boot-seal element 60 is required to exhibit higher heat resistance, durability, oil resistance, and acid resistance as well as alkali resistance at the inner face 61b than at the outer face 61c. In view of the requirement, the boot seal 50 according to Embodiment No. 2 comprises the boot-seal element 60 being made up of a double-layered construction. Specifically, the boot-seal element 60 includes an inner face being made of a fluororubber, and an outer face being made of an ethylene acrylic rubber. In particular, in the boot-seal element 60, the inner face 61b of the deformer 61 is composed of FKM, and the outer face 61c of the deformer 61 is composed of AEM. Accordingly, in addition to giving the boot- seal element 60 reliable rigidity, it is possible to keep the thickness of the fluororubber layer, namely, the thickness of the inner face 61b, down to minimum.

Consequently, it is possible to manufacture the boot-seal element 60 more inexpensively than to manufacture the boot-seal element 20 described in Embodiment No. 1 that is all made of the fluororubber alone.

The boot seal 50 according to Embodiment No. 2 comprises the retainer 45 that is provided with the plate- or sheet-shaped deformation inhibitor 70 integrally at the inner circumferential rim. As a result, an assembly worker or robot can put the deformation inhibitor 70 in place simultaneously with fixing the crankcase fitting 63 of the boot-seal element 60 onto the crankcase 42 by making use of the retainer 45. Therefore, the present boot seal 50 not only enables the assembly worker or robot to carry out the disposition of the deformation inhibitor 70 with ease, but also makes it possible for manufactures to inhibit the assembly man-hour requirements from increasing.

The boot seal 50 according to Embodiment No. 2 comprises the deformation inhibitor 70 that is disposed outside the boot-seal element 60. In addition to the disposition, the deformation inhibitor 70 includes the base end 70a, which is fixed to a given location in the crankcase 42, as well as the elongation 70b, which extends in such a direction that the cylinder block 41 and the crankcase 42 move relatively to each other. Therefore, the deformation inhibitor 70 can upgrade the relative-displacement type “VCR” engine's appearance in the decorativeness, because it makes a blind to the boot-seal element 60. Moreover, the deformation inhibitor 70 can protect the boot-seal element 60 from colliding objects. In addition, the deformation inhibitor 70 can also protect the boot-seal element 60 from heats that are evolved within the engine room of vehicle, especially from heats that come from the exhaust manifold.

### Other Embodiments

A boot seal for “VCR” engine according to the present invention is not limited to the above-described embodiments. It is needless to say that it is possible to accomplish the present boot seal in various modes to which changes and modifications, which one of ordinary skill in the art can carry out, are made within the spirit or scope of the present invention.

For example, Embodiment No. 1 employs the boot-seal element 20 that is all made of a fluororubber alone, whereas Embodiment No. 2 employs the double-layered boot-seal element 60 whose inner face and outer face are made of a fluororubber and an ethylene acrylic rubber respectively. However, the material for making the boot-seal element in a boot seal according to the present invention is not limited to the above-described rubbers. Alternatively, it is also possible to use an acrylic rubber (e.g., ACM) or silicone rubber to make an outer face of the boot-seal element 60 in the present boot seal 50 according to Embodiment No. 2, for instance. Moreover, it is even possible to make a boot-seal element of a resin.

In addition, the boot seals 10 and 50 according to Embodiment Nos. 1 and 2 comprise the boot-seal elements 20 and 60 that are provided with the deformers 21 and 61, respectively. The deformers 21 and 61 are formed as a bellows-like cylindrical shape having either one of the roots 21a and 61a that are depressed inward diametrically, respectively. However, in the present boot seals 10 and 50, the deformers 21 and 61 can have any other configuration that is not limited to the bellows-like cylindrical shape. For example, the deformers 21 and 61 can also be formed as a bellows-like cylindrical shape having a crest that is swollen outward diametrically, or can even be formed as a bellows-like cylindrical shape having crests and roots that occur one after another alternately. Note that the length of the deformers 21 and 61, and the quantity and direction of pleats (that is, crests and roots) can be set up suitably in compliance with the configuration, disposition and relative displacement magnitude of the cylinder block and/or the crankcase, or in compliance with the positional relationships between the deformers 21 and 61 and the other constituent members.

Moreover, the boot seal 10 according to Embodiment No. 1 comprises the outer metallic sheet 4a and plate- or sheet-shaped outer deformation inhibitor 31 that are made integrally with each other, the intermediate metallic sheet 4b and central-sheet end 22b that are made integrally with each other, and the inner metallic sheet 4c and plate- or sheet-shaped inner deformation inhibitor 32 that are made integrally with each other. However, these constituent members can be made independently of each other. Note that, when the constituent members are made independently of each other, the resulting independent constituent members can be fastened integrally with each other by publicly-known methods such as welding, brazing, bonding and crimping.

In addition, in Embodiment No. 1, it is also possible to fix the plate- or sheet-shaped outer deformation inhibitor 31 directly to one of the side walls of the cylinder head 3. Likewise, in Embodiment No. 1, it is also possible to fix the plate- or sheet-shaped inner deformation inhibitor 32 directly to one of the side walls of the cylinder block 1.

Moreover, the boot seal 10 according to Embodiment No. 1 comprises the plate- or sheet-shaped outer deformation inhibitor 31 and plate- or sheet-shaped inner deformation inhibitor 32 that serve as the deformation inhibitor 30. However, the present boot seal 10 can comprise either one of the outer deformation inhibitor 31 and inner deformation inhibitor 32 alone.

In addition, the boot seal 50 according to Embodiment No. 2 comprises the plate- or sheet-shaped deformation inhibitor 70 that is disposed outside the boot-seal element 60. However, the present boot seal 50 can further comprise another deformation inhibitor that is disposed inside the boot-seal element 60.

Moreover, the boot seal 50 according to Embodiment No. 2 comprises a plurality of the deformation inhibitors 70 being disposed at given locations in the whole circumference of the retainer 45 excepting the curved sections, that is, at the linear sections alone. However, the retainer 45 can also be provided with one and only deformation inhibitor, which is disposed entirely over the whole circumference of the retainer 45. If such is the case, the resultant single and integral deformation inhibitor can preferably be provided with a plurality of oil-drain holes, which pierce the deformation inhibitor from the inside to the outside or vice versa at the bottom, in order to prevent oil reservoirs from occurring between the deformation inhibitor and the boot-seal element 60.

Having now fully described the present invention, it will be apparent to one of ordinary skill in the art that many changes and modifications can be made thereto without departing from the spirit or scope of the present invention as set forth herein including the appended claims.

What is claimed is:

1. A boot seal for variable compression-rate engine, the boot seal being mounted onto a variable compression-rate engine that changes a volume of a combustion chamber by changing relative positions between a cylinder block and a crankcase, and the boot seal covering between the cylinder block and the crankcase, the boot seal comprising:
a cylindrical boot-seal element having an end being fixed to the cylinder block and another end being fixed to the crankcase, and including a bellows-shaped cylindrical deformer that is made of an elastically deformable material; and
a deformation inhibitor being disposed outside or inside the boot-seal element in order to control the deformer so as to deform outwardly or inwardly to a predetermined deformation magnitude.

2. The boot seal according to claim 1, wherein the deformation inhibitor includes:
a base end to be fixed to the cylinder block, or to a member that is fixed to the cylinder block; and
an elongation being extended from the base end in such a direction that the cylinder block and the crankcase move relatively to each other.

3. The boot seal according to claim 2, wherein the deformation inhibitor includes the base end that is held between a cylinder head and the cylinder block, and which is provided integrally with an outer circumferential rim of a metallic cylinder head gasket for sealing between the cylinder head and the cylinder block.

4. The boot seal according to claim 1, wherein the deformation inhibitor includes:
a base end to be fixed to the crankcase, or to a member that is fixed to the crankcase; and
an elongation being extended from the base end in such a direction that the cylinder block and the crankcase move relatively to each other.

5. The boot seal according to claim 4 further comprising a retainer for fixing the boot-seal element to the crankcase at the other end, wherein:
the deformation inhibitor is disposed outside the boot-seal element; and
the deformation inhibitor includes the base end that is provided integrally with the retainer.

6. The boot seal according to claim 1, wherein:
the deformation inhibitor is disposed outside the boot-seal element; and
the deformation inhibitor is provided with a heat-resistant coating that is formed on an outer face thereof at least.

7. The boot seal according to claim 1, wherein at least the deformer of the booth-seal element is made of a rubber that exhibits a safe heat-resistant temperature of 130° C. or more.

8. The boot seal according to claim 7, wherein at least the deformer of the boot-seal element is made of a fluororubber.

9. The boot seal according to claim 7, wherein the boot-seal element includes a double-layered construction whose inner face is made of a fluororubber, and whose outer face is made of an ethylene acrylic rubber.

10. The boot seal according to claim 1, wherein the deformation inhibitor has a plate or sheet shape.

11. The boot seal according to claim 1, wherein the boot-seal element has a thinner thickness at the deformer than at another part of thereof.

12. The boot seal according to claim 1 comprising a plurality of the deformation inhibitors that are separated from each other at predetermined intervals around the cylinder block.
